(19) United States
(12) Patent Application Publication
(10) Pub. No.: US 2009/0045693 A1
(43) Pub. Date: Feb. 19, 2009

(54) Flat Commutator and Method for Producing a Flat Commutator

(76) Inventor: Ernst-Rudolf Hein, Nalbach (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/886,816

(22) PCT Filed: Jun. 12, 2006
(86) PCT No.: PCT/EP2006/005593

§ 371 Date: Sep. 21, 2007

(30) Foreign Application Priority Data
Jun. 16, 2005 (DE) 10 2005 028 791.3

(51) Int. Cl. H01R 39/06; H01R 43/06

(52) U.S. Cl. 310/237; 29/597

(57) ABSTRACT

The invention relates to a flat commutator (101) comprising a support body (102) that consists of an electrically insulating material, a large number of connecting segments (108) consisting of an electrically conductive material for connecting at least one respective end of a coil winding and a large number of bearing surface segments (112), which form a bearing surface (14) of the flat commutator (101), said bearing surface segments (112) being connected to the connecting segments (108) in a mechanically permanent, electrically conductive manner and the support body (102) and/or the connecting segments (108) being configured in one piece. The support body (102) is pre-fabricated and comprises openings (118), into which the connecting segments (108) are inserted. The commutator is characterised in that the connecting segments (108) are anchored to the bearing surface segments (112) on the support body (102) by means of the permanent mechanical connection, the openings (118) in the support body (102) comprise an extended section (124, 128) in the vicinity of the end of the connecting segment (108) that faces the bearing surface segments (112), the extended section (124, 128) of the openings (118) forms a receiving chamber for a connecting agent that joins the connecting segments (108) to the bearing surface segments (112) and once the connecting agent has cured, it anchors the connecting segment (108) to the support body (102). The invention also relates to a method for producing a flat commutator.

The invention relates to a flat commutator, especially a carbon, plug-in flat commutator, and a method for producing such a flat commutator.

Flat commutators, such as these, are used for example for fuel pumps. The electrically conductive connecting segments, which usually consist of copper or which contain copper in this medium, do not have the resistance necessary for continuous operation. For this reason the bearing surface segments which have higher resistance compared to the medium surrounding the flat commutator are used for the bearing surface of the flat commutator.

Flat commutators, such as these, are known for example from WO 97/03486 A1. In this connection, a support body of electrically insulating material which forms the hub for the commutator is molded onto a conductor blank which forms one of the connecting segments. For this purpose the conductor blank is inserted into a corresponding mold and molded in the mold with a mass which forms the support body. Then a carbon ring disk which forms the bearing surface segments is soldered onto the conductor blank and then separated into bearing surface segments. Flat commutators which have been produced in this way meet high quality requirements, but the production process is accordingly complex and thus expensive.

DE 199 26 900 A1 discloses a process for producing a flat commutator in which the surfaces of the metal segment support parts exposed by the division of the support body are coated with a layer which is resistant to the environment, for example against fuels.

EP 1 363 365 A1 discloses a commutator according to the preamble of claim 1. The connecting segments have a connecting section for connecting one end of a coil winding and a contact section for electrical connection to the bearing surface segment. After inserting the connecting segments into the support body the connecting sections are bent at a right angle and parallel to the plane of the bearing surface. Then a carbon-containing disk which is divided by parting cuts is applied to the bent connecting sections and thus forms the bearing surface segments. The carbon-containing disk is composed of two layers which are connected to one another by cold pressing. The first layer assigned to the connecting segments contains a binder. When applied to the connecting segments under the action of heat the binder softens and the first layer flows with the simultaneous action of pressure into openings of the connecting segments and of the support body and thus anchors the carbon-containing disk on the support body.

Therefore the object of the invention is to make available a flat commutator and the pertinent production process which overcome the disadvantages of the prior art, are especially more economical and still ensure sufficient resistance of the commutators-produced in a-reaction-promoting environment.

The object is achieved by the flat commutator defined in claim 1 and by the production process defined in the independent claim. Special embodiments of the invention are defined in the dependent claims.

For flat commutators, in contrast to so-called barrel commutators the bearing surface for the commutator brushes is formed by a plane end surface. Accordingly the structure of flat commutators is different from to the structure of barrel commutators.

The flat commutator according to the invention has a support body of electrically insulating material, for example of a duroplastic. On the support body there are a plurality of connecting segments which are designed for connection of at least one end of a coil winding at a time, for example of the rotor of an electric motor, and which consist of a material with good electrical conductivity, for example, of copper or a copper alloy. To increase the resistance of the bearing surface of the commutator to the medium surrounding the commutator, the flat commutator moreover has a plurality of bearing surface segments which jointly form the plane bearing surface of the flat commutator, the number of bearing surface segments generally corresponding to the number of connecting segments, especially is identical to it or is an integral fraction or integral multiple of it.

According to the invention, the support body has openings into which the connecting segments are inserted. One particularity consists in that the support body as a separate part is produced before insertion of the connecting segments with its mold which has openings for accommodating the connecting segments. In this way the support body can be produced in a simplified manner with high dimensional accuracy, for example also by an injection molding process. In particular the peripheral injection of the connecting segments which is very complex in terms of production engineering is eliminated in the formation of the support body.

The support body is preferably made in one piece and specifically integrally forms the openings for insertion of the connecting segments, the contact surfaces for the prefabricated bearing surface segments, and contact surfaces for those sections of the connecting segments to which the coil winding is connected. The connecting segments are preferably made in one piece, especially the connecting segments form both the contact surfaces facing the bearing surface segments and also the connecting surfaces for the coil winding in one piece.

Because the connecting segments can be inserted into the support body, numerous advantages are ensured. Thus the requirement of producing a conductor blank which forms the connecting segments is eliminated. Moreover this conductor blank need no longer be supplied to an injection molding machine for injecting the support body on.

Furthermore it is advantageous that the connecting segments are no longer surrounded over the entire surface by the press material which forms the support body so that the different coefficients of thermal expansion of the material of the connecting segments and of the material of the support body no longer cause thermally induced stresses.

The bearing surface segments are connected mechanically tightly and by electrical conductivity to the connecting segments. This connection can take place for example by a soft solder, a hard solder, or also a cement. The bearing surface segments can be fixed individually on the respective connecting segments or fixed in a combination for example in the form of a disk or ring disk on the connecting segments and then can be separated by parting cuts. The connecting segments are also mechanically fixed on the flat commutator by the mechanically tight connection to the bearing surface segments.

The connecting segments can also be fixed solely as a result of a clamping action of the support body, and this clamping action can be caused by an at least sectional overdimension of the support body with reference to the connecting segment. If necessary, the fixing of the connecting segments on the support body can be improved by an additional connecting means, for example by a cement. In any case, by connecting the bearing surface segments to the connecting segments the fixing of the segments on the support body is at any rate further improved in the direction of stress during operation of the flat commutator.

The bearing surface segments relative to the connecting segments, especially relative to the end of the connecting segments which faces the bearing surface segments, have a projection which extends obliquely or transversely to the insertion direction, by means of which the combination of the bearing surface segment and connecting segment is anchored on the support body. In this way the combination is secured especially against shifting in the insertion direction.

The projection can be formed at least partially also by a connecting means which connects the bearing surface segment to the connecting segment, for example by a solder. Preferably the bearing surface segments in the region on the projection at least in sections abut the support body so that the support body itself forms an abutment for axial fixing of the connecting segments.

The openings in the support body for holding the connecting segments run at least partially parallel to the axis of the support body, preferably the openings extend parallel to one longitudinal axis of the support body which preferably coincides with the axis of rotation of the flat commutator. The openings in the support body are open at least in sections toward the peripheral surface of the flat commutator, especially in the section in which the connecting segment forms a preferably radially projecting connecting means for connection of the coil winding. In one alternative embodiment the openings for holding the connecting segments run in the radial or tangential direction with reference to the support body.

In the region of the end of the connecting segments facing the bearing surface segments the openings in the support body have a widening. This widening preferably forms a receiving space for a connecting means, for example a solder or cement, for connecting the connecting segments to the bearing surface segments. After setting, the connecting means preferably even by itself, especially in conjunction with the pertinent bearing surface segment, forms anchoring of the connecting segment on the support body.

This applies especially when the connecting means in the region of the transition from the connecting segment to the pertinent bearing surface segment as a result of the acting surface tension widens in the manner of a funnel, as is the case for example for solder and cement connections. In this way moreover the entry of the medium surrounding the flat commutator into the region of the connecting segments is reliably prevented and thus the connecting segments are protected against corrosion.

In this connection it is especially advantageous if the connecting segments in the inserted state with their end facing the bearing surface segments project into the region of the widening. In this case the connecting means can act not only axially on the connecting segment, but can also at least partially surround it in the peripheral direction, by which the joint action is improved. In this way the connecting means itself can form a type of tie rod and can secure the connecting segment against axial displacement.

The connecting segments have a head section and a base section which are connected to one another via a connecting section. The pertinent opening in the support body at least in sections has an overdimension, for example such that the part of the support body which lies between the head section and the base section is compressively stressed, and/or depending on the dimensioning of the connecting segments—the connecting section of the connecting segment is tensioned. It is especially advantageous here if the surfaces of the head section and base section which are generally opposite one another and which adjoin the support body include an angle of less than 90°, because then the stresses which occur in the support body as a result of the clamping of the connecting segment are largely balanced, especially these stresses run essentially in the radial direction with reference to the longitudinal axis of the flat commutator, and thus the flat commutator even in continuous operation under high stress has a stable support body.

The connecting segments are made as identical parts, especially as punched or hammered parts, or in the simplest case they are produced by cutting a corresponding section to length. With respect to matching of the geometrical dimensions of the connecting segment with reference to the pertinent opening in the support body, it is especially advantageous that precision matching of these dimensions of the connecting segment can be done with little effort by adjusting the punching tool. In this way the requirements for dimensional accuracy of the support body are reduced; this greatly simplifies its production process.

The connecting segments can have a coating at least in the region of the connection to the bearing surface segments. The material of the coating is preferably matched to the material of the connecting means, for example the connecting segments in the case of a solder connection at least in the region of the connection to the bearing surface segments, generally over the entire surface, are coated with tin or a material corresponding to the solder layer.

The bearing surface segments consist of a material which compared to the medium surrounding the flat commutator has a higher resistance than the connecting segments. Preferably the material of the bearing surface segments contains carbon, and both a so-called soft fired carbon and a hard fired carbon can be used. Preferably the bearing surface segments, however, on their sections facing the connecting segments have a coating, by which the connection is further improved.

The invention also relates to a process for producing a flat commutator in which the support body is separately produced from an electrically insulating material, in the same manner as the connecting segments which are inserted into the openings of the support body. Then the bearing surface segments which form the bearing surface of the flat commutator are fixed. The bearing surface segments can be present separated and can each be fixed individually on the pertinent connecting segment, or in combination, for example in the form of a ring disk, can be fixed on the connecting segments and then separated by parting cuts.

Other advantages, features and details of the invention will become apparent from the dependent claims and the following description in which several embodiments are described in detail with reference to the drawings. The features mentioned in the claims and specifications can each be essential for the invention individually for themselves or in any combination.

FIG. 1 shows a cross section through a flat commutator known from the prior art,

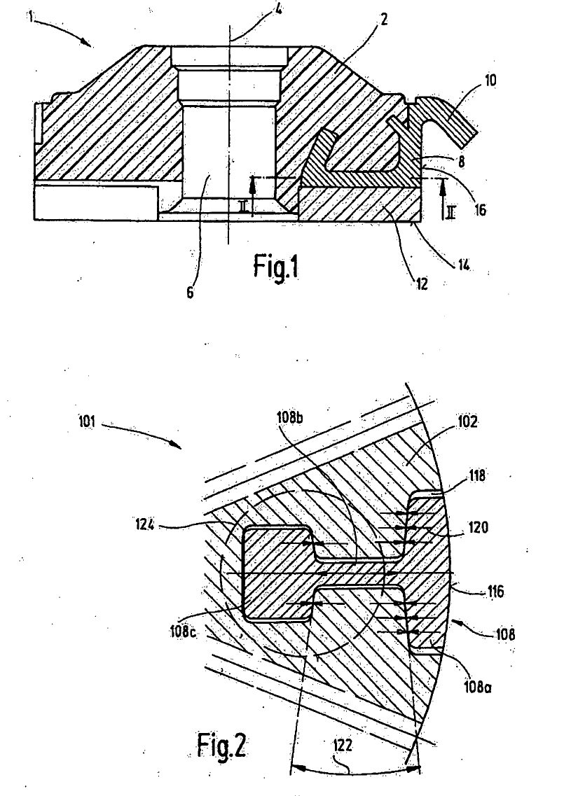

FIG. 2 shows a front view of a cross section through a flat commutator according to the invention,

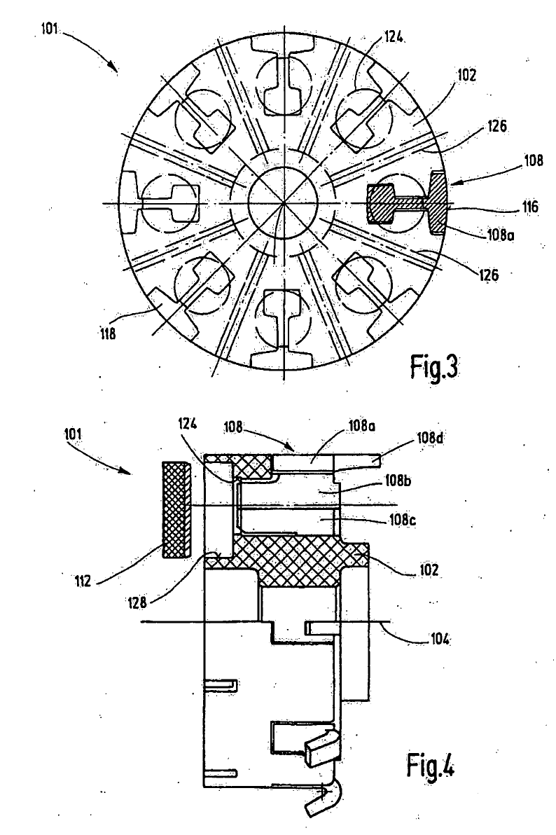

FIG. 3 shows a top view of the flat commutator,

FIG. 4 shows a side view of the flat commutator according to the invention,

FIG. 5 shows a section through a first embodiment of the connection between the connecting segment and bearing surface segment,

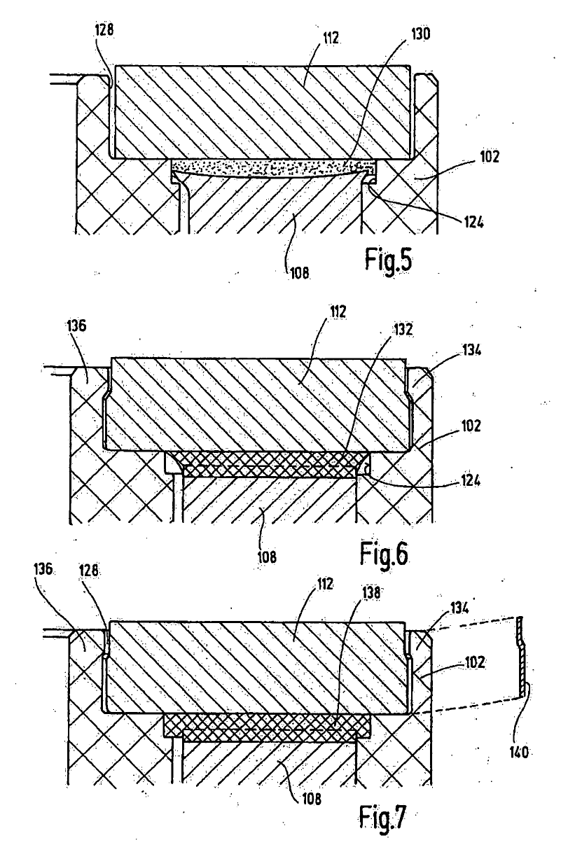

FIG. 6 shows a section through a second embodiment of the connection between the connecting segment and bearing surface segment,

FIG. 7 shows a section through a third embodiment of the connection between the connecting segment and bearing surface segment,

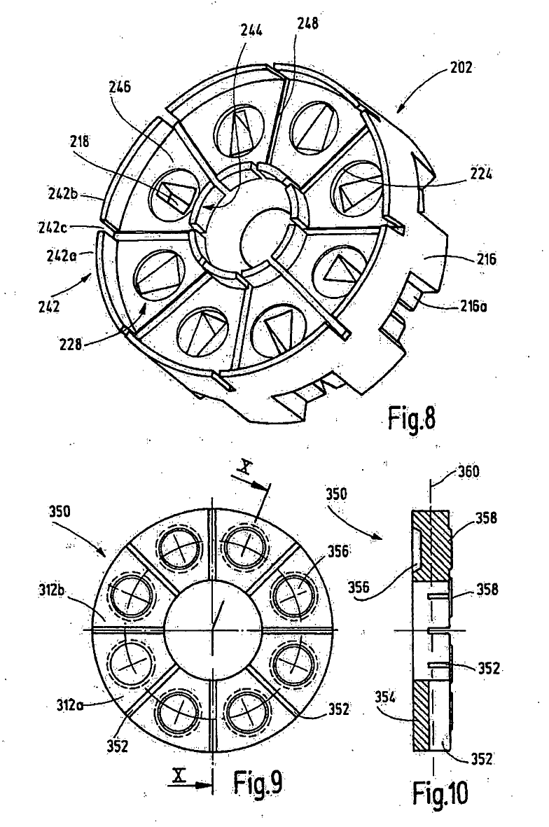

FIG. 8 shows a perspective view of a second embodiment of the support body,

FIG. 9 shows a top view of a special embodiment of the bearing surface segments,

FIG. 10 shows a section along X-X in FIG. 9,

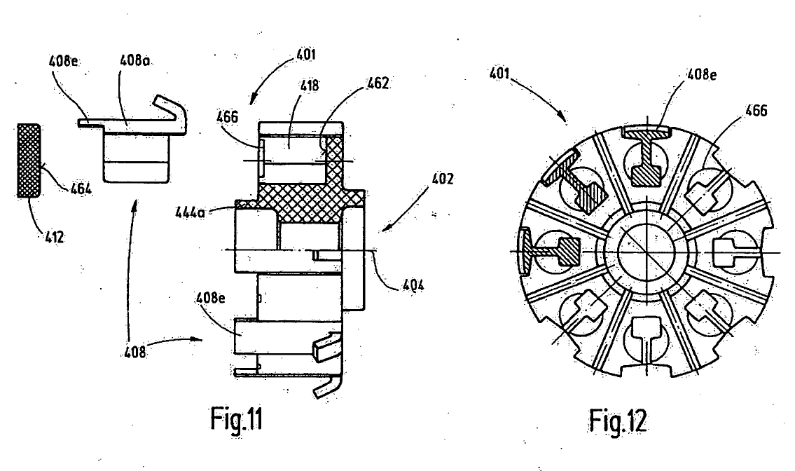

FIG. 11 shows a second embodiment of the flat commutator in a side view,

FIG. 12 shows a top view of the flat commutator of FIG. 11,

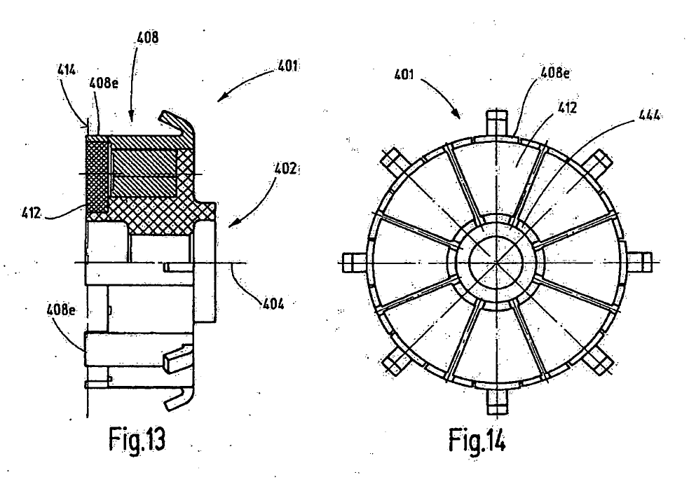

FIG. 13 shows the flat commutator of FIG. 11 in the assembled state in a side view,

FIG. 14 shows a top view of the flat commutator of FIG. 13, and

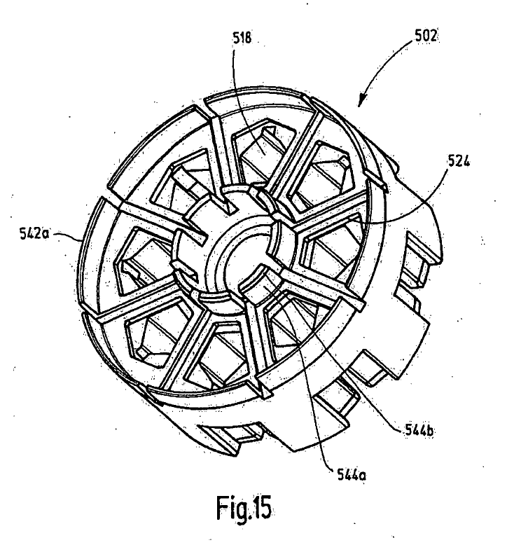

FIG. 15 shows another embodiment of the support body 502.

FIG. 1 shows a cross section through a flat commutator known from the prior art. The flat commutator 1 has a support body 2 of electrically conductive material. The support body 2 has a longitudinal axis 4 which also coincides with the axis of rotation of the flat commutator 1. In particular the flat commutator 1 can be axially symmetrical to the longitudinal axis 4. In the region of the longitudinal axis 4 the flat commutator 1, especially the support body 2, forms an opening 6 for passage of the axle of an electric motor.

The support body 2 is molded onto the connecting segments 8 which radially on the outside have a bent hook 10 for connection of at least one end of the respective coil winding. The bearing surface 14 of the flat commutator 1 is formed by bearing surface segments 12 which are connected mechanically tightly and electrically conductively to the connecting segments 8. The entirety of the bearing surface segments 12 which are located preferably uniformly distributed in a circle around the longitudinal axis 4 forms the plane bearing surface 14 of the flat commutator 1. Radially outside, the connecting segments 8 form a peripheral surface 16, from which the hooks 10 are bent off. Other details of the flat commutator 1 can be taken from WO 97/03486 A1.

FIG. 2 shows a view of a cross section through a flat commutator according to the invention, which view arises in a section corresponding to II-II in FIG. 1. The connecting segments 108 have a head section 108a and a base section 108c which are connected to one another via a connecting section 108b. FIG. 2 shows the region of a bearing surface segment (not shown) which in its contour is roughly congruent with the cut surface of the support body 102. The support body 102 has a plurality of openings 118 which are arranged distributed regularly on the circumference and into which the connecting segments 108 can be inserted. Insertion is done preferably in the direction parallel to the longitudinal axis of the flat commutator 101 which runs perpendicular to the plane of FIG. 2.

In the region of the head section 108a the opening 118 has an overdimension in the peripheral direction. This reliably prevents the pertinent underdimension of the opening 118 due to tolerances in production; this underdimension would deliver compressive stresses running in the peripheral direction into the support body 101 which can lead to problems with respect to the permanent stability of shape of the support body 102. The corresponding applies to the opening 118 in the region of the base section 108c; here the opening 118 especially in the peripheral direction has an overdimension relative to the dimensions of the base part 108c.

Also relating to its radial extension in the section between the contact surface for the region of the head section 108a, which region is pointed radially to the inside, and the contact surface for the region of the base section 108c which is pointed radially to the outside, the opening 118 with respect to the radial extension of the connecting section 108b has an overdimension so that in these regions the connecting segment 108 is in contact with the contact surfaces formed by the opening 118 and especially on these surfaces the forces indicated in FIG. 2 by the arrows 120 are applied.

This overdimension of the opening 118 causes compressive stresses to be applied to the support body 102 in the region of the connecting section 108b. The cause of these compressive stresses is the tensile stresses in the connecting section 108b, with an extension in the peripheral direction which is smaller than the corresponding extension of the head section 108a and of the base section 108c. Accordingly the connecting section 108b stretches elastically in the radial direction. The connecting segment 108 acts as an energy storage mechanism. Stretching takes place preferably within the elastic limit of the connecting segment 108, for example by an amount between 5 and 50 μm. Otherwise the opening 118 in the region of the connecting section 108b in the peripheral direction has an overdimension so that no compressive forces in the peripheral direction are applied to the molded body 102 at this location.

The angle 122 enclosed by the facing end sides of the radially outer region of the base section 108c and the radially inner region of the head section 108a is less than 90°, preferably between 30° and 60°, especially approximately 50°, and in this embodiment between 4° and 30°, especially approximately 15°. This acute angle ensures that the compressive stresses applied to the support body 102 as a result of the stretching of the connecting section 108b from the connecting segment 108 essentially mutually balance one another, especially a negligibly small resulting pressure component in the peripheral direction remains.

In the flat commutator 101 according to the invention, the connecting segments 108 and the support body 102 accordingly are joined essentially in a stress-neutral manner. The forces which occur upon insertion and which lead to effective clamping and thus fixing of the connecting segments 108 in the support body 102 are advantageously mutually cancelled. In particular no resulting forces remain which act in the peripheral direction and/or act radially to the outside so that the flat commutator 101 even under difficult conditions of use, such as for example elevated temperature, reliably retains its stability of shape.

This is also achieved preferably in that one section of the connecting segments 108 at a time is tensioned and is used as an spring-elastically deformable element. The connecting segments 108 are inserted preferably in the axial direction into the support body 102, insertion being possible fundamentally from both end sides of the support body 102. But in many cases insertion from the side of the support body 102 facing away from the bearing surface segments 112 is preferred. Profiling of the connecting segments 108 enables automatic centering of the connecting segments 108 in the support body 102 so that supply and insertion of the connecting segments 108 can be automated very easily.

Moreover, it is possible when the connecting segments 108 are inserted against a stop, to insert especially a pressure pad which can be positioned relative to the support body 102. In this connection it is advantageous for anchoring of the connecting segments 108 on the support body 102 if the stop is made for example in the form of a mandrel and makes contact in the central region of the base section 108c and causes spreading of the base section 108 there by the insertion force or pressure force upon insertion.

In the region which is associated with the contour 124 which is shown by the broken line in FIG. 2 the support body 102 near the end of the connecting segments 108 which faces the bearing surface segments 112 has a widening which can be used to accommodate the connecting means for connection between the connecting segment 108 and bearing surface segment 112.

FIG. 3 shows a top view of the flat commutator 101, especially of the support body 102, to the extent in agreement with FIG. 2, the connecting segment 108 being inserted only into the opening 118 in the three o'clock position. The other, altogether eight openings 118 in the illustrated state of the flat commutator 101 are not yet equipped with connecting segments 108. The bearing surface segments 112 are likewise not yet in place, but their contour is indicated by the broken lines 126. The head regions 108a run with their radially outer contour according to the outer contour of the support body 102 and thus in sections form a relatively flush peripheral surface 116 of the flat commutator 101.

FIG. 4 shows a side view of a flat commutator 101 according to the invention and in the bottom half of the figure in a front view and in the top figure half partially in a cross section. The connecting segment 108 shown in a front view in the top half of the figure is inserted into the support body 102 and clamped. In the illustrated state the head section 108a integrally forms a plug-in or plate connection 108d for connecting at least one coil winding. Instead of the illustrated plug-in or plate connection 108d the head section 108a in this region can also be bent in a hook shape (compare FIG. 1) or can have an insulation piercing connection which penetrates the insulation of the coil connection winding, or also a solder connection for soldering on the coil winding. Both for possible bending and also attachment of the coil connection winding is it advantageous for the connecting segment 108 in the illustrated inserted state to be connected relatively tightly to the support body 102.

In the region of the end of the connecting segment 108 facing the bearing surface segment 112 the opening 118 in the support body 102 has a first widening 124 and a second widening 128. The second widening 128 is used for optionally also positive holding of the bearing surface segments 112 and when the bearing surface segments 112 are present in combination can for example be present in the form of a ring disk, also in an annular second widening 128.

Conversely, the first widening 124 is preferably provided individually to the respective connecting segment 108, and can be made for example in a circular shape. The space radially bordered by the first widening 124 can form a receiving space for a connecting means for connecting the connecting segment 108 to the bearing surface segment 112. In this regard it is especially advantageous if the connecting segment 108 projects into the region of the first widening 124 in the axial direction, i.e., in the direction parallel to the longitudinal axis 104, with its end facing the bearing surface segment 112. In this case the connecting means can adjoin the axial end side of the connecting segment 108 not only superficially, but can also overlap it in the manner of a cap and moreover can effect an additional seal between the connecting segment 108 and the support body 102. Preferably the connecting segment 108 at least on its end facing the bearing surface segment has a coating which improves the mechanical connection and/or electrical contact-making.

Due to the radial projection of the bearing surface segment 112 relative to the connecting segment 108 this arrangement after connection forms a reliable attachment to the support body 102 in the manner of anchoring, especially relative to axially acting forces; This attachment is further improved by the bearing surface segment 112 at least in sections being in preferably planar contact with the support body 102.

The bearing surface segments can have several layers, especially can be a multilayer disk before segmenting. The multilayer disk can have a carbon layer or carbon-containing layer which forms the bearing surface, and another layer which faces the connecting segments and which has at least one metallic component, for example copper, tin, brass or alloys. The other layer is used especially to improve the electrical and/or mechanical connection to the connecting segments. The multilayer disk can be produced by a sintering process. Alternatively, after the shaping process the disk can also be coated.

FIG. 5 shows a section through a first embodiment of the connection between the connecting segment 108 and the bearing surface segment 112. The particularity of this first embodiment is among other things that the connecting segment 108 when inserted into the support body 102 would be pressed against a stop, an abutment, a mandrel or the like such that a projection which extends into the first widening 124, especially a radial projection is formed which provides for secure axial anchoring of the connecting segment 108 in the support body 102, especially by engagement of the connecting segment with the undercut formed by the first widening 124.

This anchoring is further strengthened by the mechanically tight and electrically conductive connection of the connecting segment 108 to the bearing surface segment 112, this connection in the illustrated first embodiment taking place by means of an electrically conductive cement layer 130. The cement layer 130 adjoins not only the end surface of the connecting segment 108 and the corresponding end surface of the bearing surface segment 112, but also fills the region of the first widening 124 in the radial direction, so that sealing and especially complete coverage of the connecting segment 108 are ensured by the cement layer 130. It is also possible to cement the connecting segments 108 themselves to the support body 102.

FIG. 6 shows a second embodiment of the connection between the connecting segment 108 and the bearing surface segment. 11 2. A first difference from the first embodiment consists in the type of connecting layer, this second embodiment being a solder layer 132 which as a result of the acting surface tension has a funnel-shaped widening in the direction to the bearing surface segment 112 and in this way and especially without the connecting segment 108 having to be spread, provides for radial engagement with the region of the first widening 124 and thus for formation of a tie rod with respect to the axial mobility of the connecting segment 108.

Another particularity of the second embodiment consists in the type of shaping of the front-side end of the support body 102. It tapers the second widening 128 on the end side, for example by means of the first projection 134 which is pointed radially inside and which is located radially outside, and/or by means of the second projection 136 which is pointed radially outside and which is located radially inside. The pertinent bearing surface segments 112 are accordingly made step-shaped and with their end facing the connecting segments 108 extend behind the first and/or second projection 134, 136 of the second widening 128. The corresponding shape of the bearing surface segments 112 can be made available either in the shaping process or, for example in the case of attaching the bearing surface segments 112 in combination in the form of a ring disk, by turning such a ring disk.

By the matched shaping of the support body 102 and the bearing surface segments 112, it is possible to clip the bearing surface segments 112 into the second widening 128, i.e., to fix them on the support body 102 by spring locking. For a corresponding, especially axial projection of the connecting segment 108 into the region of the second widening 128, and/or for a corresponding, especially axial projection of the bearing surface segments 112 into the region of the first widening 124, it is also possible for a mechanically relatively strong and electrically relatively conductive connection between the bearing surface segments 112 and the connecting segments 108 to be made available solely by the locking of the bearing surface segments 112 on the support body 102. The locking of the bearing surface segments 112 on the support body 102 in any case yields the advantage of pre-fixing which in subsequent cementing or soldering provides for the bearing surface segment 112 to be and remain in the correct position with respect to the pertinent connecting segment 108. Moreover the bearing surface segment 112 can also be held in especially flat contact with the support body by locking.

In addition to the solder layer 132 shown in FIG. 6, an additional sealing means can be inserted into the annular gap which is formed between the bearing surface segments 112 and the support body 102, for example also an adhesive layer, in order to prevent entry of corrosive media into these regions.

FIG. 7 shows a third embodiment of the connection between the connecting segments 108 and the bearing surface segments 112. A first difference from the other two embodiments is that the connecting layer 138 between the connecting segments 108 and the bearing surface segments 112 essentially completely fills the space of the first widening 124 and in this way also forms an absolutely reliable seal of the support body 102 relative to the connecting segments 108.

Another particularity consists in that the support body 102 on its axial end in the region of the second widening 128 does in turn provide a taper with the formation of annular or partially annular, optionally also only spot projections 134, 136 which with respect to their dimensions can even be identical to those of the second embodiment of FIG. 6, that however the dimensions of the bearing surface segment 112 are less that the inside width of the second widening 128 which is determined by the two projections 134, 136. In this way, when the bearing surface segment 112 is inserted into the second widening 128 the bearing surface segment 112 is not clipped in, but can be loosely inserted.

If at this point the resulting annular gap between the bearing surface segment 112 and the support body 102 is filled for example with a hardenable mass, especially a cement, in this way a preferably annular locking body 140 is formed which fills the annular gap and which ensures positive fixing of the bearing surface segments 112 on the support body 102 as a result of its shape and as a result of the interaction with the contour of the support body 102 in the embodiment of FIG. 7 with the first and/or second projection 134, 136 and with the contour of the bearing surface segment 112.

In all three embodiments relating to the connection between the connecting segment 108 and the bearing surface segment 112, the connecting layers 130, 132, 138 form a rim, funnel or some other type of anchor element which extends into the first widening and by which the connecting segment 108 and thus also the bearing surface segment 112 are permanently and reliably fixed in the axial direction on the support body 102.

FIG. 8 shows a perspective view of a second embodiment of a support body 202. The first difference from the support body 102 of the first embodiment consists in the essentially trapezoidal cross sectional contour of the opening 218 for the connecting segments. Besides this, the first widening 224 is circular in a top view and in the illustrated second embodiment covers the entire opening 218. The first widening 224 in turn forms a deposition space for a connecting means. Altogether the support body 202 has eight openings 218 for the connecting segments.

The second widening 228 is bordered radially to the outside by an outer ring 242 which is formed integrally by the support body 202 and radially inside by an inner ring 244 which is formed in one piece by the support body 202. Both the outer ring 242 and also the inner ring 244 are formed by ring segments 242a, 242b which are assigned to the respective bearing surface segments. Between adjacent ring segments 242a, 242b there is a respective recess 242c with an extension in the peripheral direction which is larger than the width of the tool for segmenting of the bearing surface segments. In this way it is possible to separate the bearing surface segments which are fixed in a combination, for example as a ring disk, on the support body 202 or the pertinent connecting segments by parting cuts, without in doing so having to cut the outer and/or inner ring bridge 242, 244. In this way the service life of the cutting tool is greatly increased. Moreover a higher cutting speed can be achieved because breaking out of the outer ring 242 and/or of the inner ring 244 need no longer be prevented by a reduction of the cutting speed.

Another particularity of the support body 202 consists in that in the contact surface 246 of the support body 202 there are recesses for the segmenting of the ring disk, especially radially running grooves 248 which are flush with the corresponding recesses 242c in the outer ring 242 and inner ring 244. The depth of these grooves 248 is chosen such that reliable separation of the ring disk is ensured without sawing into the support body. If these grooves 248 are still filled with a preferably electrically nonconductive cement, not only is the additional connection of the bearing surface segments with the support body 202 ensured, but also the generally carbon-containing bearing surface segments are reliably prevented from breaking out when being cut apart.

In particular by using a support body 202 with an outer ring 242, a so-called soft-fired carbon can also be used for the bearing surface segments, i.e., a plastic-bonded carbon with an exact composition which can be selected matching with the pertinent commutator brushes. In the region of the peripheral surface 216 the support body 202 has recesses 216a which are used to hold the connecting segments, especially for that section of the connecting segments which is intended for connecting the coil windings.

In the production of the flat commutator according to the invention it is especially also possible, after inserting the connecting segments 108 into the support body 102, in the region of the first widening 124 or over the entire surface into the region of the contact surface 246 to insert a preferably anaerobically setting and electrically conductive cement or some other electrically conductive connecting means, and especially the first widening 124 can be used as a kind of deposition space for such a connecting means. To improve the connection between the connecting segment 108 and the bearing surface segment 112 the bearing surface segment 112 can be accordingly coated, for example tin-plated, at least on the surface facing the connecting segment 108, optionally also over the entire surface.

FIG. 9 shows a top view of one special embodiment of the bearing surface segments, specifically in the form of a presegmented bearing surface disk 350. FIG. 10 shows a section along X-X in FIG. 9.

This bearing surface disk 350 can be segmented by radial parting cuts into individual bearing surface segments 312a, 312b. In this case this segmenting is achieved by the radial grooves 352 which have already been molded in when the bearing surface disk 350 is shaped, in conjunction with reduction of the thickness of the bearing surface disk 350. The depth of the grooves 352 extends, as shown especially by the cross section in FIG. 10, only to approximately half the thickness of the bearing surface disk 350. In particular, in the region of the bearing surface disk 350 which faces away from the support body, there remains a connecting ring 354 which interconnects the individual bearing surface segments 312a, 312b to one another. In the region of this connecting ring 354 there are handling or tool action surfaces 356 by means of which the bearing surface disk 350 can be supplied mechanically to the respective support body in an automatic manner. The tool action surfaces 356 can be uniformly distributed in the peripheral direction, especially in the region of the bearing surface segments 312a, 312b.

On the side facing the support body the bearing surface disk 350 forms projections 358 which can be matched with respect to their number and/or arrangement to the arrangement of the bearing surface segments 312a, 312b. In particular these projections 358 can be matched in their shape and arrangement to the first widening 224 which is provided on the support body 202, especially can engage them positively. Simplified positioning of the bearing surface disk 350 on the support body 302 is thus ensured.

After connecting the bearing surface disk 350 to the connecting segments and the support body 202, the bearing surface disk 350 on its exposed flat surface can be turned to the height which is indicated in FIG. 10 by the dot-dash line 360. In this way turning into the region of the grooves 353 takes place so that the bearing surface segments 312a, 312b are separated thereby. Therefore it is no longer necessary to make parting cuts.

FIG. 11 shows a second embodiment of a flat commutator 401 in a side view, in the not yet assembled state. The support body 402 is shown in part in a section in the top half of the figure and in a front view in the bottom half of the figure. In the bottom half of the figure the support body 402 is moreover shown with the inserted connecting segments 408.

One particularity compared to the previous embodiments consists in that the connecting segment 408, especially its head section 408a, preferably integrally forms a collar 408e which forms at least in sections the outer ring 242 which is formed in the embodiment of FIG. 8 from the support body 202. In this way radially outside protection for the bearing surface segments 412 and/or a contact surface for positioning and alignment of the bearing surface segments 412 is formed. Moreover in this way the connecting segment 408 can be additionally fixed when the coil winding is being welded on, especially in the radial direction.

Another particularity consists in that the connecting segment 408 can be inserted from the side of the support body 402 facing the bearing surface segments 412. The connecting segments 408 are inserted until they strike the pertinent stop surfaces 462 of the support body 402 which preferably include a right angle with the longitudinal axis 404. The bearing surface segments 412 on their surface 464 facing the connecting segments 408 have a coating, for example of tin, copper, or brass, by which a reliable mechanical and electrical connection to the connecting segments 408 is ensured.

FIG. 12 shows a top view of the embodiment of FIG. 11. The collar 408e in a top view is arc-shaped relative to the longitudinal axis 404 with an angle of arc of roughly half the angle of arc of a bearing surface segment 412; in this embodiment the angle of arc of the collar 408e is approximately 20°.

FIG. 13 shows the flat commutator 401 of FIG. 11 in the assembled state in a side view. On the end side of the support body 402 facing the bearing surface segments 412 there is a recess 466 which is round in this embodiment (FIG. 11) and which forms a deposition space for the connecting means for connecting the connecting segment 408 to the pertinent bearing surface segment 412. In the illustrated mounted state the collar 408e axially has a projection over the exposed flat surface of the bearing surface segment 412. By subsequent material removal, especially by turning flat, the connecting segments 408, the bearing surface segments 412 and the support body 402 are leveled to form the bearing surface 414 of the flat commutator 401.

In one special alternative embodiment the collar 408e conversely does not have an axial projection over the exposed flat surface of the bearing surface segment 412, but is set back relative to the flat surface or even relative to the bearing surface 414, especially set back by one or more tenths of a millimeter relative to the bearing surface 414. In this way when the bearing surface segments 412 are leveled, the material of the collar 408e need not be removed, by which the process for example of flat turning is simplified. Typically the bearing surface segments 412 in a disk combination have a thickness of approximately 2.5 mm which is reduced by flat turning to approximately 2 mm. The axial length of the collar 408e is typically between 1.5 and 1.8 mm.

In this alternative embodiment as well, the support body 402 can have ring segments 444a which form the inner ring and which axially have a projection distance over the exposed flat surface of the bearing surface segments 412. In particular, these ring segments on their facing end can have a bevel (see also FIG. 15) by which insertion of the bearing surface segments 412 is simplified. In particular when the bearing surface segments 412 are inserted in a disk combination, the axial projection of the ring segments 44a reliably prevents tilting of the disk on the collar 408e and thus the danger of damage to the disk.

FIG. 14 shows the pertinent top view of the flat commutator 401 of FIG. 13. The collar 408e radially outside forms the support ring for the bearing surface segments 412, conversely the support body 402 radially inside forms a support by the inside ring 444 which is made in one piece.

FIG. 15 shows another embodiment of a support body 502. In contrast to the embodiment of FIG. 8, the openings 518 are adapted for holding the connecting segments, their base section having roughly the shape of a kite, the radially inside tip of the kite being flattened and the radially outside tip of the kite undergoing transition into the opening for the connecting section. The angle enclosed by the facing surfaces of the radially outer region of the base section and of the radially inner region of the head section of the connecting segments (compare FIG. 2) is between 30° and 60°, especially approximately 50°.

The first widening 524 is matched to the cross sectional shape of the base section of the connecting segments and is especially pentagonal in the illustrated embodiment. The overlapping of the first widening 524 with reference to the opening 518 in the peripheral direction is comparatively small or even negligible in the region of the radially running boundary lines of the cross sectional shape of the opening 518. There is conversely a projection which anchors the connecting segment in the support body 502 especially radially inside and radially outside to the other boundary lines of the cross sectional shape of the opening 518.

The ring segments 544a which form the inner ring on their face end have a bevel 544b which is pointed radially to the outside and which simplifies insertion of the bearing surface segments (not shown in FIG. 15). Accordingly the ring segments 542a which form the outer ring can also have a bevel which is pointed radially to the inside.

1. Flat commutator (101) having a support body (102) of electrically insulating material, a plurality of connecting segments (108) of an electrically conductive material for connection of at least one end of a coil winding at a time, and a plurality of bearing surface segments (112) which form a bearing surface (14) of the flat commutator (101), the bearing surface segments (112) being connected mechanically tightly and by electrical conductivity to the connecting segments (108), and the support body (102) and/or the connecting segments (108) being made in one piece, and the support body (102) being prefabricated and having openings (118) into which the connecting segments (108) are inserted, characterized in that the connecting segments (108) are anchored on the support body (102) by the mechanically tight connection to the bearing surface segments (112), that the openings (118) in the support body (102) in the region of the end of the connecting segments (108) which faces the bearing surface segments (112) have a widening (124, 128), that the widening (124, 128) of the openings (118) forms a receiving space for a connection means for connecting the connecting segments (108) to the bearing surface segments (112), and wherein the connecting means forms anchoring of the connecting segment (108) on the support body (102) after setting.

2. The flat commutator (101) according to claim 1, wherein the bearing surface segments (112) have a projection relative to the connecting segments (108) in the radial direction and/or peripheral direction, relative to the axis of rotation of the flat commutator (101).

3. The flat commutator (101) according to claim 2, wherein the bearing surface segments (112) in the region of the projection at least in sections abut the support body (102).

4. The flat commutator (101) according to claim 1, wherein the support body (102) in the region of the openings (118) with respect to the inserted connecting segments (108) at least in sections has an overdimension.

5. The flat commutator (101) according to claim 1, wherein the openings (118) in the support body (102) run with at least one directional component parallel to a longitudinal axis (104) of the support body (102), especially wherein the openings (118) extend parallel to the longitudinal axis (104) of the support body (102).

6. The flat commutator (101) according to claim 5, wherein the connecting segments (108) in the inserted state with their end facing the bearing surface segments (112) project into the region of the widening (124, 128).

7. The flat commutator (101) according to claim 1, wherein the connecting segments (108) have a head section (108a) and a base section (108c) which are connected to one another via a connecting section (108b), and wherein the connecting section (108b) as a result of an overdimension of the support body (102) at least in sections is elastically deformed in the region of the opening (118) and thus the connecting segments (108) are fixed on the support body (102) by clamping.

8. The flat commutator (101) according to claim 1, wherein the connecting segments (108) have a coating at least in the region of the connection to the bearing surface segments (112).

9. Process for producing a flat commutator (101) with the following steps:
producing a support body (102) of an electrically insulating material, the support body (102) having openings (118) for accommodating the connecting segments (108) of an electrically conductive material for connection of at least one end of the respective coil winding,
insertion of the connecting segments (108) into the openings (118) of the support body (102), the openings (118) in the support body (102) in the region of the end of the connecting segments (108) which faces the bearing surface segments (112) having a widening (124, 128), and the widening (124, 128) of the openings (118) forming a receiving space for a connecting means for connecting the connecting segments (108) to the bearing surface segments (112), fixing of the bearing surface segments (112) which form the bearing surface of the flat commutator (101) on the flat commutator (101) by mechanically strong and electrically conductive connection of the bearing surface segments (112), individually or in combination, with the connecting segments (108) using a connecting means which forms anchoring of the connecting segment (108) on the support body (102) after setting.

10. The process according to claim 9, wherein the connecting segments (108) upon insertion into the support body (102) in the region of their end facing the bearing surface segments (112) undergo a widening in the radial direction and/or peripheral direction, with respect to the axis of rotation of the flat commutator (101).
